(19) United States
(12) Patent Application Publication
(10) Pub. No.: US 2015/0024620 A1
(43) Pub. Date: Jan. 22, 2015

(54) Electric Connector

(71) Applicant: IRISO ELECTRONICS CO., LTD., Kanagawa (JP)

(72) Inventors: Hiroaki Kobayashi, Kanagawa (JP); Hidehiro Shindo, Kanagawa (JP); Shigeru Mitsuzuka, Kanagawa (JP)

(73) Assignee: IRISO ELECTRONICS CO., LTD., Kanagawa (JP)

(21) Appl. No.: 14/306,874

(22) Filed: Jun. 17, 2014

(30) Foreign Application Priority Data
Jul. 19, 2013 (JP) 2013-150064

(51) Int. Cl. H01R 13/62

(52) U.S. Cl. CPC H01R 13/62
USPC 439/345

(57) ABSTRACT

A socket terminal includes a front connection portion that comes into contact with a plug terminal, in which a recess having an inner wall is formed in a contact surface that comes into contact with the front connection portion. The front connection portion is locked on the inner wall by coming into contact with the inner wall when moving in a direction in which the plug terminal is pulled out from the socket terminal. The front connection portion also includes a contact edge that wipes impurities off the contact surface. An electrical connection between the socket terminal and the plug terminal can be maintained by locking the socket terminal on the inner wall even with an application of vibrations in directions in which the plug terminal is inserted and pulled out. Since the contact edge can remove the impurities, the electrical connection between the terminals can be stabilized.

### BACKGROUND OF THE INVENTION

1. Field of the Invention

The present invention relates to an electric connector that electrically connects circuit boards to each other.

2. Description of the Related Art

A floating connector that includes a plug and a socket and that can correct displacement between the plug and the socket relative to each other is known to date as an electric connector that maintains a connection between circuit boards regardless of an application of vibrations. Examples of electric connectors that have been developed to, particularly, highly reliably connect terminals to each other include an electric connector in which an S-shaped movable portion is provided on a socket terminal so that the socket is movable relative to the plug (Japanese Unexamined Patent Application Publication No. 2011-249076). Such an electric connector can maintain the plug and the socket in a correct fitting state due to the movable portion of the socket terminal absorbing vibrations that would occur when either the substrate on which the plug is mounted or the substrate on which the socket is mounted is displaced.

Some electric connectors, such as an electric connector used as a component of an automobile or a precision machine, are used in an environment subject to large impacts or vibrations. Although an electric connector used in such an environment can maintain the plug and the socket in a correct fitting state at the beginning, it may fail to maintain stable electrical connection due to an insufficient contact between the terminals upon receipt of an impact or vibrations during use. Examples of causes that make an electrical connection between the terminals unstable include impurities such as substrate residues or dust adhering to the plug terminal. A countermeasure for such impurities is essential to establish a highly reliable connection between terminals.

### SUMMARY OF THE INVENTION

The present invention was made to solve the above problems. Specifically, the present invention aims to provide an electric connector that can reliably maintain a connection between terminals even when the plug and the socket receive an impact or vibrations while being in a fitted state. The present invention also aims to provide an electric connector that can reliably maintain a connection between terminals even when impurities adhere to the plug terminal.

In order to achieve the above-described object, an aspect of the present invention has the following structure.

Specifically, an aspect of the invention provides an electric connector including a plug including a plug terminal and a socket including a socket terminal, the plug terminal and the socket terminal coming into contact with each other and being electrically connected to each other when the plug and the socket are fitted together, wherein the socket terminal includes a connection portion that comes into contact with the plug terminal, and wherein the plug terminal includes a locking portion on a contact surface that comes into contact with the connection portion of the socket terminal, the connection portion being locked on the locking portion by coming into contact with the locking portion when moving in a direction in which the plug terminal is pulled out from the socket terminal.

The socket terminal includes a connection portion that comes into contact with the plug terminal. The plug terminal includes a locking portion on a contact surface that comes into contact with the connection portion of the socket terminal, the connection portion being locked on the locking portion by coming into contact with the locking portion when moving in a direction in which the plug terminal is pulled out from the socket terminal. Thus, even when an impact or vibrations is/are applied to the electric connector, the state where the connection portion and the contact surface are in contact with each other can be maintained by preventing the plug from being pulled out from the socket with a force that is weaker than or equal to a predetermined pulling force. Thus, the electrical connection between the plug terminal and the socket terminal can be maintained.

In an aspect of the present invention, a recess, at which a plate surface of the plug terminal is recessed, can be formed in the contact surface of the plug terminal as the locking portion. The socket terminal and the plug terminal can be locked together as a result of the connection portion of the socket terminal entering the recess while the plug and the socket are fitted together.

When the terminals are locked together as a result of the connection portion entering the recess, the inner walls of the recess can restrict the movement of the connection portion. In addition, an electrical connection between the plug terminal and the connection portion can be established as a result of the connection portion coming into contact with the inner walls of the recess. Moreover, an operator can receive a tactile “click” response when the connection portion enters the recess while the plug and the socket are being fitted together and thus can manually perceive the progress on the fitting of the socket and the plug.

In an aspect of the present invention, a through hole, which passes through the thickness of the plug terminal, can be formed in the contact surface of the plug terminal as the locking portion, and the socket terminal and the plug terminal can be locked together as a result of the connection portion of the socket terminal entering the through hole while the plug and the socket are fitted together.

Unlike the recess, the through hole does not have an electric bottom of the terminal. Thus, by forming the through hole in the contact surface of the plug terminal that serves as a locking portion, the connection portion is allowed to deeply enter the through hole, so that the terminals can be locked together.

In an aspect of the present invention, a protrusion, which protrudes from the contact surface of the plug terminal, can be disposed on the contact surface of the plug terminal as the locking portion, and the socket terminal and the plug terminal can be locked together when the plug terminal moves in the direction in which the plug terminal is pulled out while the plug and the socket are fitted together as a result of the connection portion of the socket terminal crossing the protrusion of the plug terminal.

The connection portion of the socket terminal can be reliably fitted to the plug terminal as a result of the connection portion locking on the protrusion, which is disposed on the contact surface of the plug terminal as a locking portion, at a position across the protrusion.

In an aspect of the present invention, a movable-range gap that allows displacement in directions in which the plug terminal is inserted into and pulled out from the socket terminal while the plug and the socket are fitted together is provided between the connection portion of the socket terminal and the locking portion of the plug terminal so that the plug and the socket are displaceable relative to each other in the directions in which the plug terminal is inserted into and pulled out from the socket terminal while the plug and the socket are fitted together.

Thus, the displacement of the plug in the directions in which the plug is inserted and pulled out can be absorbed by moving the connection portion within the movable-range gap even when an impact or vibrations is/are applied to the plug in the directions in which the plug is inserted and pulled out.

In an aspect of the present invention, the connection portion of the socket terminal can include a contact edge that wipes away an impurity that adheres to the contact surface of the plug terminal by sliding over the contact surface, and the contact surface of the plug terminal includes an impurity remover that scrapes the impurity off the contact edge of the socket terminal that has wiped away the impurity as a result of the contact edge sliding over the impurity remover.

The impurities adhering to the contact surface of the plug terminal that have been wiped away as a result of the contact edge sliding over the contact surface include not only dust simply adhering to the surface but also impurities stuck fast to the contact surface such as substrate residues. Providing the impurity remover, which scrapes impurities off the contact edge, on the contact surface of the plug terminal enables reliable removal of the impurities adhering to the surface of the contact edge from the contact edge, thereby establishing a stable electrical connection between the connection portion and the contact surface.

In an aspect of the present invention, a recess can be formed in the contact surface of the plug terminal and an opening edge of the recess can serve as the impurity remover.

Using the opening edge of the recess as an impurity remover allows the impurities at the contact edge to be scraped off as a result of the contact edge sliding over the opening edge of the recess from the state where the connection portion is in the recess. Moreover, since the removed impurities can be housed in the recess, the impurities scraped off the contact edge can be prevented from adhering to the contact surface again.

In an aspect of the present invention, a through hole can be formed in the contact surface of the plug terminal and an opening edge of the through hole can serve as the impurity remover.

By providing the through hole in the contact surface, the connection portion can be more deeply inserted into the through hole. Thus, the impurities can be reliably scraped off as a result of the contact edge coming into contact with the opening edge.

In an aspect of the present invention, a protrusion can be formed on the contact surface of the plug terminal and a step surface of the protrusion can serve as the impurity remover.

By using the step surface of the protrusion as an impurity remover, the impurities adhering to the contact edge can be reliably scraped off by causing the contact edge to slide over the step surface.

In an aspect of the present invention, the contact surface of the plug terminal has side locking surfaces that restrict sideways displacement of the connection portion of the socket terminal in a width direction of the plug terminal.

Providing such side locking surfaces enables restriction of displacement of the connection portion in the width direction even when an impact or vibrations is/are applied in the width direction of the plug terminal while the plug and the socket are fitted together.

In an aspect of the present invention, the side locking surfaces can be recessed so as to face each other in the width direction of the plug terminal.

In this structure, the connection portion can be enclosed by multiple side locking surfaces, whereby the movement of the connection portion can be restricted to the range enclosed by the side locking surfaces.

In an aspect of the present invention, the side locking surfaces can be formed as inner surfaces of a recess or a through hole serving as the locking portion.

In this structure, the connection portion can be inserted into the recess or the through hole and the displacement of the connection portion can be restricted to the range enclosed by the inner surfaces of the recess or the through hole.

In an aspect of the present invention, the contact surface of the plug terminal can include inclined surfaces that position the connection portion of the socket terminal by causing the connection portion to slide over the inclined surfaces in the width direction of the plug terminal.

In this structure, the connection portion can be guided to the normal contact position by being caused to slide over the inclined surfaces even when the connection portion is almost displaced from the normal contact position, at which the connection portion is normally in contact with the contact surface, in the width direction of the plug terminal upon receipt of an impact or vibrations.

In an aspect of the present invention, the contact surface of the plug terminal can include inclined surfaces that position the connection portion of the socket terminal by causing the connection portion to slide over the inclined surfaces in at least one of a direction in which the plug terminal is inserted and a direction in which the plug terminal is pulled out.

By providing such inclined surfaces, the connection portion can be guided to the normal contact position by being caused to slide over the inclined surfaces even when the connection portion is almost displaced from the normal contact position in the directions in which the plug terminal is inserted and pulled out upon receipt of an impact or vibrations.

In an aspect of the present invention, the inclined surfaces can be recessed so as to face each other.

When the connection portion is disposed between the opposing inclined surfaces so as to be enclosed by the inclined surfaces while the plug and the socket are fitted together, the connection portion can be returned to the normal contact position by being guided by the inclined surfaces even after the connection portion is moved toward the inclined surfaces from the normal contact position.

In an aspect of the invention, the inclined surfaces can be formed as inner surfaces of a recess or a through hole serving as the locking portion.

In this structure, the inner surfaces of the recess or the through hole can have a guide function that allows the connection portion to slide into the recess or the through hole.

In an aspect of the invention, the socket terminal can include a contact portion, which includes the connection portion, and an elastic portion, which elastically supports the contact portion, and the contact portion can include a front connection portion and a rear connection portion, the front connection portion being used as the connection portion that slides over the plug terminal first and wipes away an impurity that adheres to the contact surface of the plug terminal while the plug and the socket are being fitted together, the rear connection portion coming into contact with the wiped contact surface of the plug terminal subsequent to the front connection portion.

If one connection portion is used to wipe away impurities and to establish an electrical connection with the contact surface, the impurities may adhere to the connection portion and the electrical connection with the contact surface may become unstable. In contrast, such an inconvenience can be avoided by separately providing, to the socket terminal, a front connection portion, which wipes away the impurities adhering to the contact surface of the plug terminal, and a rear connection portion, which comes into contact with the wiped contact surface of the plug terminal. Moreover, the adhesion of the impurities to the rear terminal can be avoided as a result of the rear connection portion coming into contact with a portion of the contact surface from which the impurities have been wiped away by the front connection portion.

In an aspect of the invention, the socket terminal includes a front terminal that includes a contact portion and an elastic portion, the contact portion including the connection portion, the elastic portion elastically supporting the contact portion; and a rear terminal that includes a contact portion and an elastic portion, the contact portion being electrically connected to the plug terminal, the elastic portion elastically supporting the contact portion.

When the elastic portion that elastically supports the connection portion and the elastic portion that elastically supports the contact portion electrically connected with the plug terminal are separately provided, the contact portion including the connection portion and the contact portion electrically connected with the plug terminal can be moved independently of each other. Thus, the connection portion and the contact portion can be brought into contact with the contact surface without being affected by each other in terms of the contact pressure.

In an aspect of the invention, the socket terminal includes a substrate connection portion that is to be fixed to a circuit board, a movable connection portion including a connection portion, and a movable portion that elastically supports the substrate connection portion and the movable connection portion so that the substrate connection portion and the movable connection portion are displaceable relative to each other.

In this structure, the movable portion can absorb the displacement even when an impact or vibrations is/are applied to the electric connector or the circuit boards. Thus, by making the movable connection portion displaceable relative to the substrate connection portion, an electrical connection between the socket terminal and the plug terminal can be maintained by displacing, for example, the movable connection portion in a direction away from the plug terminal.

In an aspect of the invention, the socket can include a fixed housing that is to be fixed to a circuit board and a movable housing that is to be fitted to a housing of the plug and the socket terminal can elastically support the fixed housing and the movable housing so that the fixed housing and the movable housing are displaceable relative to each other.

When the socket includes the fixed housing and the movable housing and the socket terminal elastically supports these housings so that these housings are displaceable relative to each other, an embodiment of the present invention can be made as a floating connector that has the above-described operations and effects and that establishes a highly reliable connection.

According to the present invention, an electrical connection between the socket terminal and the plug terminal can be maintained by locking the socket terminal on the locking portion even with an application of an impact or vibrations. Moreover, the electrical connection between the plug terminal and the socket terminal can be stabilized by removing impurities adhering to the plug terminal. In this manner, the plug terminal and the socket terminal can be highly reliably connected together.

### BRIEF DESCRIPTION OF THE DRAWINGS

FIG. 1 is a perspective view of a floating connector according to a first embodiment.

FIG. 2 is a cross-sectional view of the floating connector taken along the line II-II of FIG. 1.

FIGS. 3A and 3B illustrate a recess, where FIG. 3A is a perspective view of the recess and FIG. 3B is a front view of the recess.

FIGS. 4A and 4B are cross-sectional views of a socket terminal and a plug terminal illustrating the way in which the socket terminal and the plug terminal are locked together, where FIG. 4A illustrates the state before locking and FIG. 4B illustrates the state after locking.

FIGS. 5A and 5B are cross-sectional views of a socket terminal and a plug terminal illustrating the way in which a front connection portion removes impurities, where FIG. 5A illustrates the state where the front connection portion wipes away impurities and FIG. 5B illustrates the state where the front connection portion finishes removing the impurities.

FIG. 6 illustrates a socket terminal according to a second embodiment.

FIGS. 7A and 7B illustrate a locking portion according to a third embodiment, where FIG. 7A is a perspective view of a through hole and FIG. 7B is a cross-sectional view of the through hole.

FIGS. 8A and 8B illustrate a protrusion according to a fourth embodiment, where FIG. 8A is a perspective view of the protrusion and FIG. 8B is a cross-sectional view of the protrusion.

FIGS. 9A and 9B illustrate a recess according to a fifth embodiment, where FIG. 9A is a perspective view of the recess and FIG. 9B is a cross-sectional view of the recess.

FIGS. 10A and 10B illustrate a recess according to a sixth embodiment, where FIG. 10A is a perspective view of the recess and FIG. 10B is a cross-sectional view of the recess.

FIGS. 11A and 11B illustrate a recess according to a seventh embodiment, where FIG. 10A is a perspective view of the recess and FIG. 10B is a cross-sectional view of the recess.

FIGS. 12A and 12B illustrate recesses according to an eighth embodiment, where FIG. 10A is a perspective view of the recesses and FIG. 10B is a cross-sectional view of the recesses.

### DESCRIPTION OF THE PREFERRED EMBODIMENTS

Referring now to the drawings, embodiments of the present invention will be described below. Components that are common across the embodiments described below are denoted by the same reference symbols and are not redundantly described.

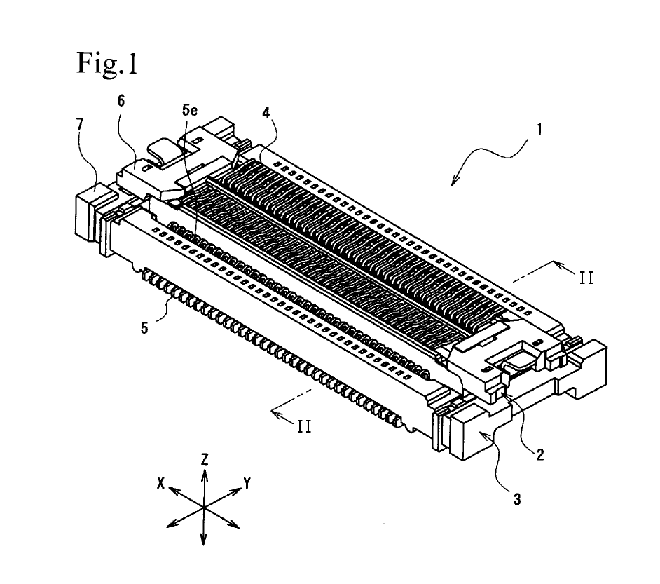

### First Embodiment (FIG. 1 to FIG. 5B)

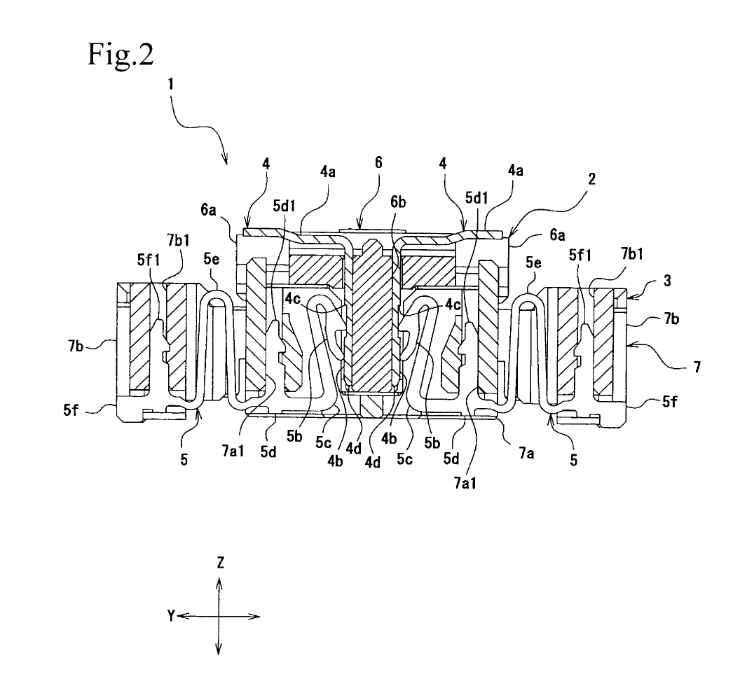

As illustrated in FIGS. 1 and 2, a floating connector 1, which is an example of “an electric connector” of the present invention, includes a plug 2 and a socket 3. The plug 2 includes plug terminals 4 and the socket 3 includes socket terminals 5.

### Plug

The plug 2 includes a plug housing 6 and multiple plug terminals 4 attached to the plug housing 6. The plug housing 6 has a substantially T-shaped cross section. The plug housing 6 includes a substantially rectangular-parallelepiped terminal holding portion 6a that extends parallel to a circuit board (not illustrated) and a plug body 6b that extends toward the socket 3 from the center position in the cross direction of the terminal holding portion 6a. The plug housing 6 is made of an insulating resin.

### Plug Terminal

The plug terminals 4 have a substantially L-shaped cross section. The plug terminals 4 are attached to the plug housing 6 while being divided into two groups and disposed on both sides of the plug body 6b. The plug terminals 4 are attached to the plug body 6b and the terminal holding portion 6a at regular intervals in the longitudinal direction of the plug 2.

Each plug terminals 4 includes a substrate connection portion 4a at which the plug terminal 4 is fixed to the circuit board and a contact portion 4d disposed along the plug body 6b.

The contact portion 4d has a contact surface 4b on a side facing the socket terminals 5. The contact surface 4b is electrically connected to the corresponding socket terminal 5. The contact surface 4b is a surface of a flat board having a width in the direction in which the plug terminals 4 are arranged. A recess 4c having an angular-c-shaped cross section is formed in the contact surface 4b.

In the following description, the longitudinal direction of the floating connector 1 is described as an X direction (in the direction of arrows X in each drawing), the cross direction of the floating connector 1 is described as a Y direction (in the direction of arrows Y in each drawing), and the direction in which the plug 2 is inserted into and pulled out from the socket 3 is described as a Z direction (in the direction of arrows Z in each drawing).

### Recess

As illustrated in FIGS. 2 to 4B, the recess 4c is formed around the center of the contact surface 4b in the Z direction and defined by inner walls 4c1 to 4c4 and a back wall 4c5. The inner walls 4c1 to 4c4 are disposed perpendicularly to the surface of the contact portion 4d. The inner walls 4c1 and 4c3 have flat surfaces extending in the X direction and the inner walls 4c2 and 4c4 have flat surfaces extending in the Z direction. The inner wall 4c1 disposed on the side closer to the socket 3 in the Z direction serves as a “locking portion”. As described below, when the plug 2 is to be pulled out from the socket 3, the front connection portion 5a of the socket terminal 5 comes into contact with the inner wall 4c1 and is locked on the inner wall 4c1.

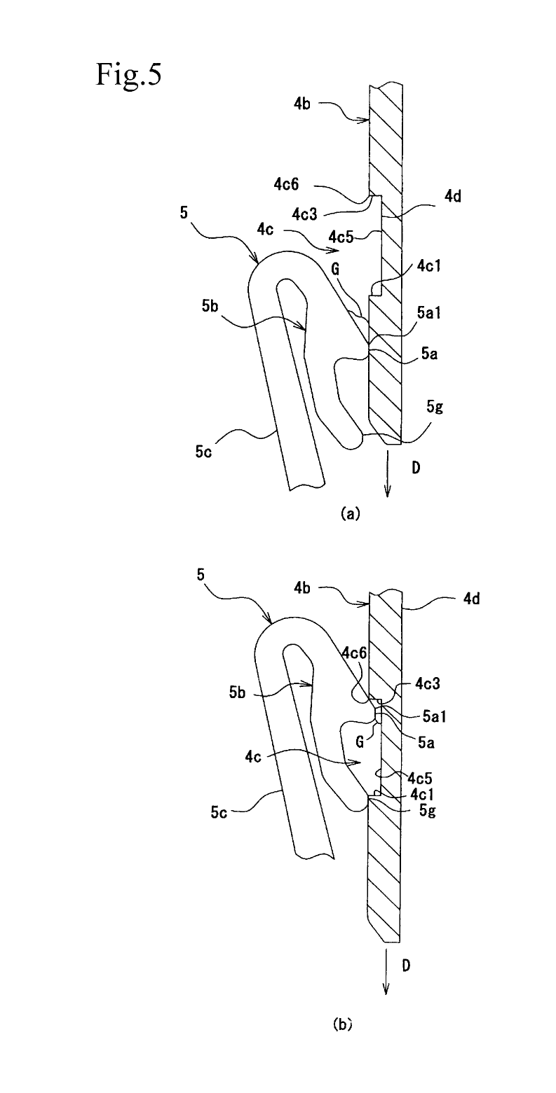

As illustrated in FIGS. 5A and 5B, an opening edge 4c6 of the inner wall 4c3 that faces the inner wall 4c1 serves as an “impurity remover”. The opening edge 4c6 can scrape impurities G on the contact surface 4b that have been wiped by a front connection portion 5a off the front connection portion 5a. The front connection portion 5a will be described below.

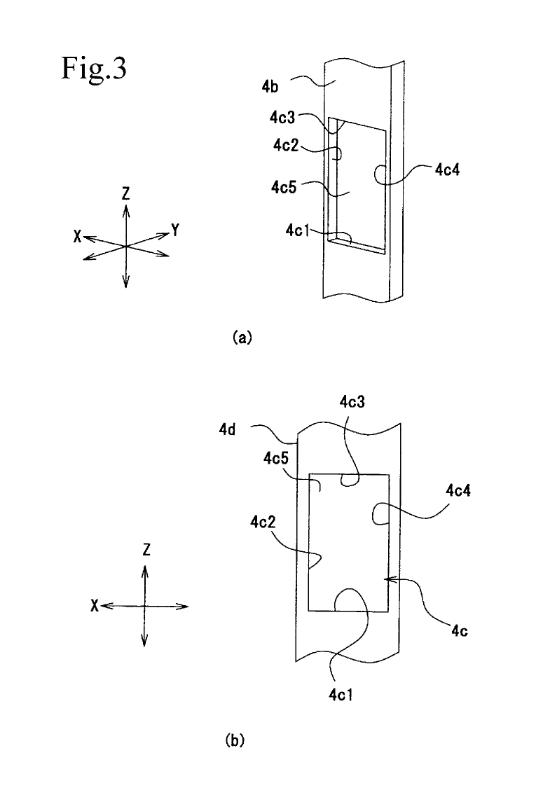

As illustrated in FIGS. 3A and 3B, among the inner walls 4c1 to 4c4 that define the recess 4, the inner walls 4c2 and 4c4 perpendicular to the inner walls 4c1 and 4c3 are parallel to each other and function as “side locking surfaces”. When the socket terminal 5 receives vibrations in the X direction while the front connection portion 5a is inserted in the recess 4c, the front connection portion 5a comes into contact with the inner walls 4c2 and 4c4 and is locked on the inner walls 4c2 and 4c4. In this manner, the front connection portion 5a can be prevented from being displaced in the X direction.

In the floating connector 1, a movable housing 7a is displaceable relative to fixed housings 7b. Thus, the socket terminals 5 and the plug terminals 4 are more likely to rub against one another. When the front connection portions 5a and the rear connection portions 5g rub against the contact surface 4b, the plating on the surfaces of the terminals may be removed. However, the inner walls 4c1 and 4c3 prevent each front connection portion 5a from being displaced in the Z direction relative to the corresponding plug terminal 4 and the inner walls 4c2 and 4c4 similarly prevent each front connection portion 5a from being displaced in the X direction relative to the corresponding plug terminal 4. Thus, removal of the plating on the contact surface 4b and the front terminals 5a due to slight sliding movement of the floating connector 1 can be prevented.

As a result of preventing the front connection portion 5a from being displaced, the entirety of each socket terminal 5 is prevented from being displaced, whereby the rear connection portion 5g is prevented from being displaced. The rear connection portions 5g and the contact surface 4b can be prevented from rubbing against each other, whereby removal of the plating of the rear connection portions 5g and the contact surface 4b can be prevented.

### Socket

The socket 3 includes a socket housing 7 and socket terminals 5. The socket housing 7 includes a substantially rectangular-parallelepiped movable housing 7a and a pair of fixed housings 7b that are disposed in the longitudinal direction of the movable housing 7a so as to sandwich the movable housing 7a. The socket housing 7 is made of an insulating resin. The movable housing 7a has fixing holes 7a1 and the fixed housings 7b each have fixing holes 7b1. The fixing holes 7a1 and 7b1 are provided for fixing the socket terminals 5 to the socket housing 7.

### Socket Terminal

As illustrated in FIG. 2, each socket terminal 5 includes a contact portion 5b, a substantially S-shaped elastic portion 5c, a base portion 5d adjacent to the elastic portion 5c, an inverted-U-shaped movable portion 5e, and a substrate connection portion 5f that is connected to a circuit board. The base portion 5d has a fixed-to-housing piece 5d1 that is fixed to the movable housing 7a and the substrate connection portion 5f has a fixed-to-housing piece 5f1 that is fixed to the corresponding fixed housing 7b.

The socket terminals 5 are arranged while being divided into two groups so as to face each other and extend in the longitudinal direction of the socket housing 7. The socket terminals 5 are formed by punching a flat metal sheet into terminals and thus are flat shaped without being bent in the thickness direction. Thus, more terminals can be arranged at a narrower pitch than in the case of terminals bent in the thickness direction. Each socket terminal 5 has a contact portion 5b at the tip portion. The contact portion 5b has a front connection portion 5a and a rear connection portion 5g that protrude toward the contact surface 4b. The elastic portion 5c elastically supports the contact portion 5b so as to allow the front connection portion 5a and the rear connection portion 5g to come into contact with the contact surface 4b. When the rear connection portion 5g comes into contact with the contact surface 4b, an electrical connection between the socket terminal 5 and the plug terminal 4 is established.

The contact portion 5b, the elastic portion 5c, and the base portion 5d disposed on a first end side of the socket terminal 5 are housed in the movable housing 7a and are fixed to the movable housing 7a by pressure-inserting the fixed-to-housing piece 5d1 into the fixing hole 7a1 of the movable housing 7a. A second end side of the socket terminal 5 is fixed to the corresponding fixed housing 7b by pressure-inserting the fixed-to-housing piece 5f1 of the substrate connection portion 5f into the fixing hole 7b1.

A movable portion 5e shaped like a spring is disposed between the movable housing 7a and each fixed housing 7b. Even when the floating connector 1 receives vibrations, the movable portion 5e allows the movable housing 7a to be displaced relative to the fixed housing 7b. Displacement of the socket terminal 5 relative to the corresponding plug terminal 4 due to vibrations being applied to the floating connector 1 is absorbed by the movable portion 5e. Thus, the electrical connection between the socket terminals 5 and the plug terminals 4 can be easily maintained.

### Method for Locking Socket Terminal on Plug Terminal

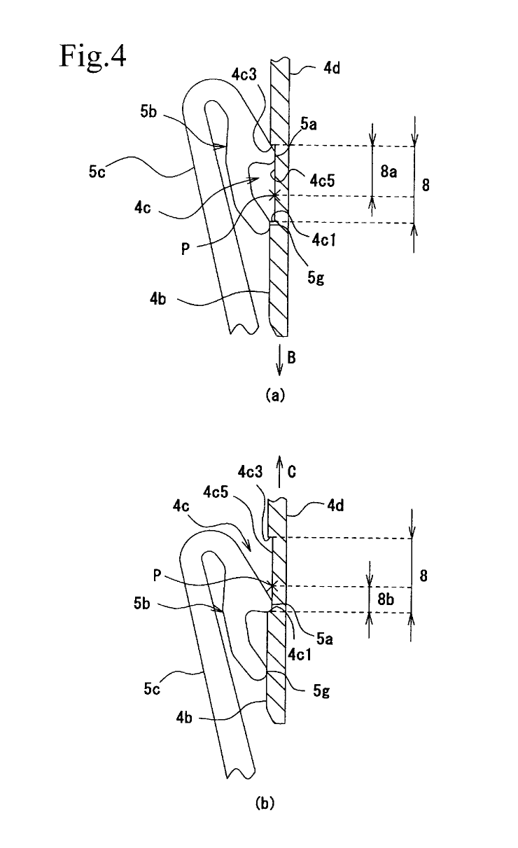

The front connection portion 5a and the rear connection portion 5g are provided in order from the leading end side at the end of each contact portion 5b. Firstly, when the plug 2 is inserted into the socket 3, the front connection portions 5a and the rear connection portions 5g come into contact with the contact surface 4b in this order. When the plug 2 is inserted into the socket 3 further, each recess 4c is moved to the corresponding front connection portion 5a as illustrated in FIG. 4A and the front connection portion 5a enters the recess 4c. Thus, the socket 3 and the plug 2 are fitted together. While the socket 3 and the plug 2 are fitted together, the rear connection portions 5g come into contact with the contact surfaces 4b and thus the electrical connection between the plug terminals 4 and the socket terminals 5 is established.

An operator (not illustrated) can receive a tactile “click” response when the front connection portions 5a enter the recesses 4c and thus can manually perceive the progress on the fitting of the socket 3 and the plug 2.

When large vibrations are applied in the direction in which the plug 2 is pulled out (in the direction of arrow C in FIG. 4B) while the plug 2 and the socket 3 are fitted together, each front connection portions 5a is moved in the direction opposite to the direction of arrow C as illustrated in FIG. 4B. The front connection portion 5a then comes into contact with the corresponding inner wall 4c1 and is locked on the inner wall 4c1.

Here, the shape of each front connection portion 5a or each recess 4c1 may be changed in accordance with the removability of the plug 2 that has been set in advance to such a degree with which the front connection portion 5a can cross the corresponding inner wall 4c1. For example, each front connection portion 5a may be shortened in the Y direction so as not to be inserted into the corresponding recess 4c to an excessively deep point or the front connection portion 5a may have a rounded tip so as to be capable of easily crossing the corresponding inner wall 4c1. Similarly, shallowing each recess 4c by shortening the corresponding inner walls 4c1 to 4c4 in the Y direction allows the corresponding front connection portion 5a to easily cross the inner wall 4c1. In these manners, the operation of removing the plug 2 from the socket 3 can be facilitated.

On the other hand, each front connection portion 5a may be lengthened in the Y direction so as to be deeply inserted into the corresponding recess 4c or the front connection portion 5a may have a tapered end so that the front connection portion 5a becomes unlikely to cross the inner wall 4c1. Alternatively, deepening each recess 4c by lengthening the inner walls 4c1 to 4c4 in the Y direction allows the corresponding front connection portion 5a to be deeply inserted into the recess 4c so that the front connection portion becomes unlikely to cross the inner wall 4c1.

### Floating Function in Z Direction

Typical electric connectors with the floating structure allow displacement in the X direction and the Y direction. In the floating connector 1 according to this embodiment, however, the movable portions 5e allows the movable housing 7a to be displaced relative to the fixed housings 7b not only in the X direction and the Y direction but also in the Z direction. Specifically, the floating connector 1 according to this embodiment of the present invention has a movable-range gap 8 between the opposing inner walls 4c1 and 4c3 of each recess 4c so that the corresponding front connection portion 5a can move in the Z direction while being inserted into the recess 4c. This structure thus enables complex displacement in the X, Y, and Z directions.

Here, displacement in the Z direction is specifically described.

In the floating connector 1 according to this embodiment, each front connection portion 5a is in contact with the corresponding back wall 4c5 at a normal contact position P when the socket 3 is fitted to the plug 2 in a predetermined normal fitting position. For example, when large vibrations are applied to the floating connector 1 in the direction in which the plug 2 is inserted (in the direction of arrow B of FIG. 4A), each front connection portion 5a can move in the corresponding movable-range gap 8 by a range 8a between the normal contact position P and the inner wall 4c3.

On the other hand, when large vibrations are applied to the floating connector 1 in the direction in which the plug 2 is pulled out (in the direction of arrow C of FIG. 4B), each front connection portion 5a can move in the corresponding movable-range gap 8 by a range 8b between the normal contact position P and the inner wall 4c1. In this case, the front connection portion 5a comes into contact with the inner wall 4c1 and is locked on the inner wall 4c1. Thus, the front connection portion 5a can be displaced in the Z direction while the electrical connection between the plug terminal 4 and the socket terminal 5 is maintained.

### Method for Removing Impurities From Plug Terminal

Impurities G such as substrate residues or dust adhere to the contact surface 4b in some cases. If a rear connection portions 5g comes into contact with the contact surface 4b to which impurities G adhere, the impurities G may be jammed between the rear connection portion 5g and the contact surface 4b, thereby possibly making the electrical connection between the socket terminal 5 and the plug terminal 4 unstable. However, since each front connection portion 5a is provided in front of the corresponding rear connection portion 5g, as illustrated in FIG. 5A, the impurities G can be wiped away from the contact surface 4b by causing a contact edge 5a1, at which the front connection portion 5a comes into contact with the contact surface 4b, to slide over the contact surface 4b when the plug 2 is inserted into the socket 3 in the direction of arrow D. Thus, as illustrated in FIG. 5B, the rear connection portion 5g comes into contact with a portion on the contact surface 4b over which the front connection portion 5a has passed and from which the impurities G have been removed, so that the socket terminal 5 and the plug terminal 4 can be electrically connected to each other in a stable manner.

When the plug 2 is deeply inserted into the socket 3, each front connection portion 5a enters the corresponding recess 4c and then the contact edge 5a1 comes into contact with the opening edge 4c6 of the inner wall 4c3 of the recess 4c. Then, the contact edge 5a1 in this state rubs against the opening edge 4c6, whereby the impurities G that have been removed from the contact surface 4b and that adhere to the contact edge 5a1 are rubbed off. The impurities G rubbed off the contact edge 5a1 in this manner are housed in the recess 4c and can thus be prevented from adhering to the contact surface 4b again.

In this floating connector 1, by inserting each front connection portion 5a into the corresponding recess 4c used as a “locking portion”, the plug 2 can be prevented from being pulled out from the socket 3, whereby the electrical connection between the plug terminal 4 and the socket terminal 5 can be maintained. In addition, since the contact edge 5a1 of the front connection portion 5a wipes the impurities G away and the rear connection portion 5g comes into contact with a portion of the contact surface 4b from which the impurities G have been removed, a highly reliable connection can be established.

In each socket terminal 5 of the floating connector 1, the front connection portion 5a and the rear connection portion 5g are provided at the same contact portion 5b. Thus, compared to the case where the front connection portion 5a and the rear connection portion 5g are provided at different contact portions 5b, the plug terminal 4 is more easily insertable into the socket terminal 5. Specifically, when the front connection portion 5a firstly comes into contact with the contact surface 4b, the contact portion 5b and the elastic portion 5c are pressed by the contact surface 4b and displaced in a direction away from the contact surface 4b. Then, in this state, the plug 2 can be smoothly inserted into the socket 3. Thus, the floating connector 1 can have high insertability while including a large number of plug terminals 4 and socket terminals 5.

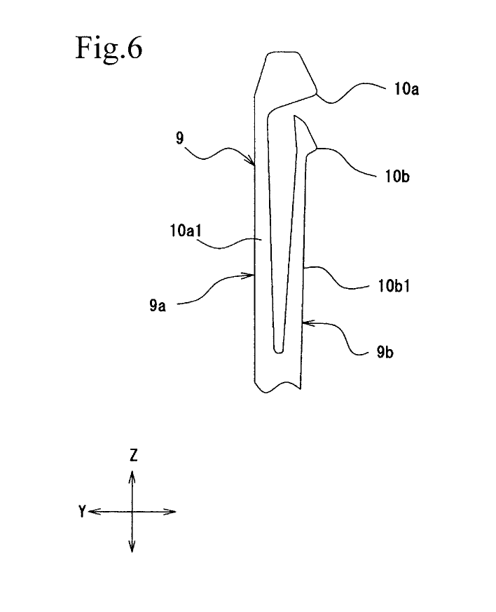

### Second Embodiment (FIG. 6)

As described above as an example, each socket terminal 5 according to the first embodiment includes a front connection portion 5a and a rear connection portion 5g disposed on one substantially S-shaped elastic portion 5c.

As illustrated in FIG. 6, however, another example of a socket terminal may be a socket terminal 9 that includes a front terminal 9a, which includes a front connection portion 10a and an elastic portion 10a1, and a rear terminal 9b, which includes a rear connection portion 10b and an elastic portion 10b1. In this case, the rear connection portion 10b and the front connection portion 10a are aligned in the Z direction in such a manner that the front connection portion 10a is disposed closer to the plug 2 than the rear connection portion 10b in the Z direction. This structure allows the front connection portion 10a to come into contact with the contact surface 4b before the rear connection portion 10b when the plug 2 is inserted into the socket 3.

In the socket terminal 9, the front connection portion 10a and the rear connection portion 10b are respectively provided to different elastic portions 10a1 and 10b1 and thus can be displaced independently of each other. The rear connection portion 10b is thus negligibly displaced as a result of displacement of the front connection portion 10a in a direction away from the contact surface 4b when the front connection portion 10a is brought into contact with the contact surface 4b and then pressed against the contact surface 4b. This structure can thus prevent undesired situation such as an unstable electrical connection due to a reduction of the contact pressure of the rear connection portion 10b against the contact surface 4b. Moreover, the front connection portion 10a is negligibly displaced as a result of displacement of the rear connection portion 10b in a direction away from the contact surface 4b when the plug 2 is inserted into the socket 3 and the rear connection portion 10b comes into contact with the contact surface 4b. This structure can thus prevent an undesired situation such as insufficient removal of impurities G by wiping due to a reduction of the contact pressure of the front terminal 9a against the contact surface 4b.

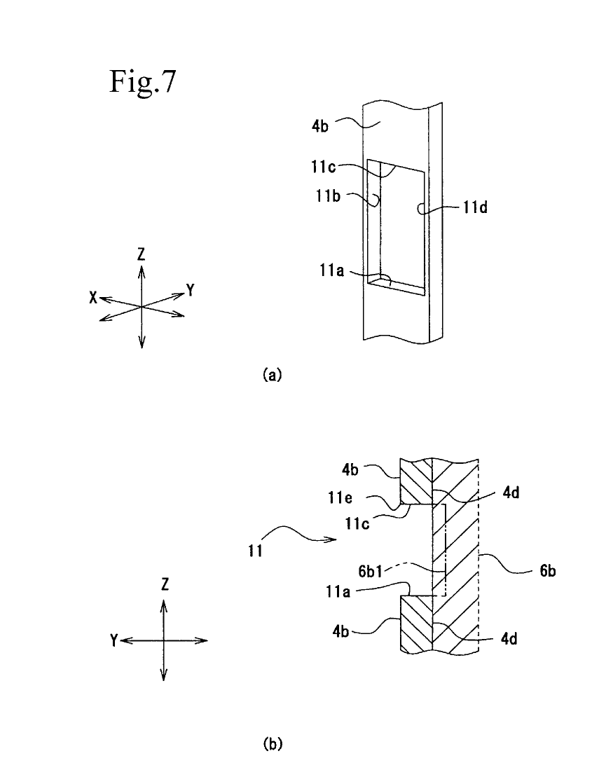

### Third Embodiment (FIG. 7A)

Some embodiments describe each recess 4c formed in the contact surface 4b as a “locking portion”. Here, the inner wall 4c1 of each recess 4c serves as a “locking portion” on which the corresponding front connection portion 5a is locked and the opening edge 4c6 of the inner wall 4c3 serves as an “impurity remover” to scrape off impurities G that have adhered to the contact edge 5a1. The scraped impurities G can be housed in the recess 4c.

As illustrated in FIG. 7A, however, a through hole 11 may be formed in the contact surface 4b instead of the recess 4c. Here, among inner walls 11a to 11d that define the through hole 11, the inner wall 11a disposed on a side closer to the socket 3 in the Z direction may be used as a “locking portion” and an opening edge 11e of the inner wall 11c that opposes the inner wall 11a may be used as an “impurity remover”. When the through hole 11 is formed in the contact surface 4b instead of the recess 4c, the front connection portion 5a can be inserted into the through hole 11. Since the through hole 11 does not have a back wall 4c5 unlike the recess 4c, the front connection portion 5a can be more deeply inserted into the through hole 11. The deep insertion enables firm locking of the front connection portion 5a on the plug terminal 4, whereby a reliable electrical connection between the plug terminal 4 and the socket terminal 5 can be established.

Moreover, the inner wall 11a can prevent the front connection portion 5a from moving in the direction in which the plug 2 is pulled out even when the plug 2 is moved in that direction since the front connection portion 5a is in firm contact with the inner wall 11a. Similarly to some embodiments, when the front connection portion 5a is deeply inserted into the through hole 11, an operator can receive a stronger tactile “click” response and can manually perceive the progress on the fitting of the socket 3 and the plug 2.

### Modified Example of Third Embodiment (FIG. 7B)

The third embodiment has described an example in which the plug body 6b is not processed. As illustrated in FIG. 7B, however, a recess 6b1 may be formed in the plug body 6b in accordance with the shape of the through hole 11. This structure enables deeper insertion of the front connection portion 5a into the through hole 11 and more securely prevents the plug 2 from being pulled out, whereby a more reliable electrical connection between the plug terminal 4 and the socket terminal 5 can be established. In addition, impurities G can be more deeply pushed toward the plug terminal 4 and thus the impurities G are unlikely to be returned to the contact surface 4b. Consequently, the electrical connection between the plug terminal 4 and the socket terminal 5 can be stabilized further.

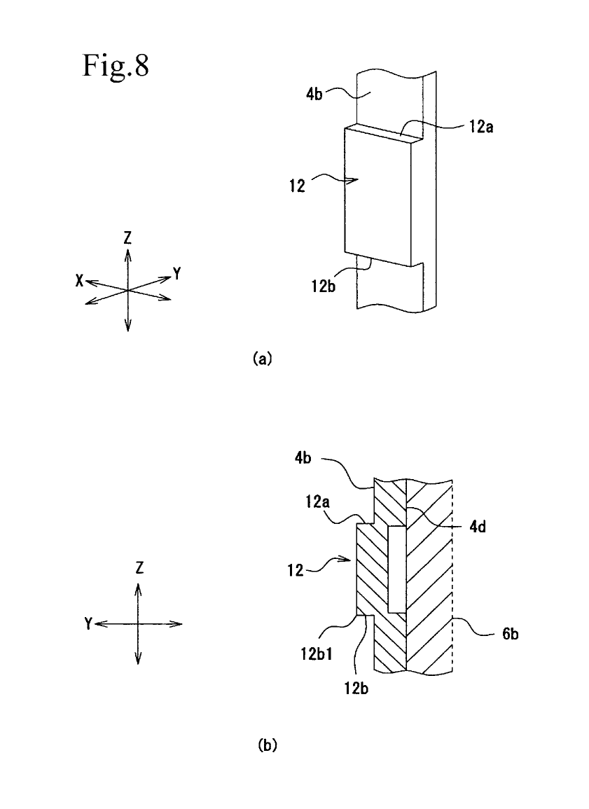

### Fourth Embodiment (FIGS. 8A and 8B)

The third embodiment has described an example in which the through hole 11 is formed in the contact surface 4b so as to function as a “locking portion”. Examples of the “locking portion”, however, include a protrusion 12 that protrudes from the contact surface 4b toward the front connection portion 5a, as illustrated in FIGS. 8A and 8B.

In this structure, when the plug 2 is to be fitted into the socket 3, each front connection portion 5a is caused to cross the protrusion 12 in the direction in which the plug 2 is pulled out. The protrusion 12 has an upper step portion 12a on a side closer to the plug 2 in the Z direction, as a “locking portion”. Specifically, when the plug 2 is moved in the direction in which the plug 2 is pulled out from the socket 3 while the front connection portion 5a is positioned on a side closer to the plug 2 than the upper step portion 12a, the front connection portion 5a comes into contact with the upper step portion 12a and is locked on the upper step portion 12a.

The protrusion 12 also has a lower step portion 12b on a side closer to the socket 3 in the Z direction. The lower step portion 12b has a lower edge 12b1, which can function as an “impurity remover”. In this structure, impurities G that have adhered to the contact edge 5a1 can be scraped off by rubbing the contact edge 5a1 against the lower edge 12b1 when the front connection portion 5a crosses the protrusion 12. In this case, the front connection portion 5a that has crossed the protrusion 12 no longer comes into contact with the impurities G that have been scraped off the contact edge 5a1 and then adhered to the lower edge 12b. Thus, additional adhesion of the impurities G to the front connection portion 5a can be prevented.

Furthermore, an operator can receive a tactile click response and can manually perceive the progress on the fitting of the socket 3 and the plug 2 when the front connection portion 5a crosses the protrusion 12. Thus, a reliable electrical connection between the plug terminal 4 and the socket terminal 5 can be established.

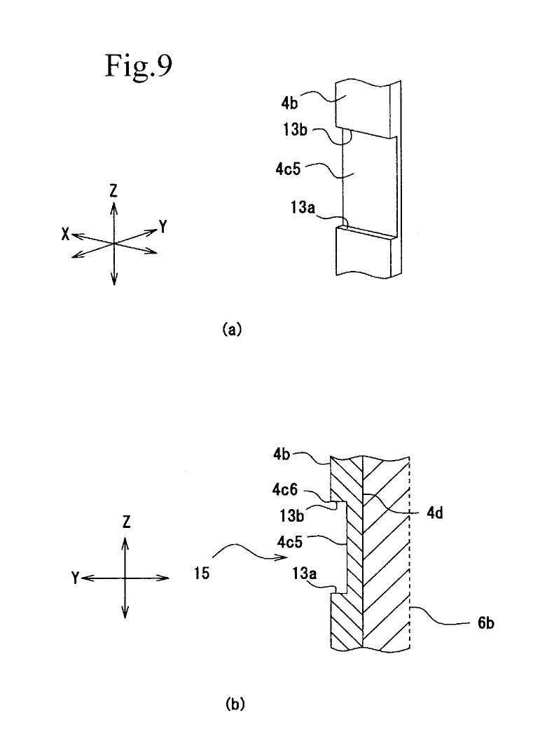

### Fifth Embodiment (FIGS. 9A and 9B)

Some embodiments have described examples in which the recess 4c, the through hole 11, or the like includes inner walls parallel to the Z direction. As illustrated in FIGS. 9A and 9B, however, a recess 15 that only includes inner walls 13a and 13b parallel to the X direction without including inner walls parallel to the Z direction may be provided instead. In this case, the inner walls 13a and 13b can restrict the movement of the front connection portion 5a in terms of only the Z direction. Thus, the floating connector 1 allows a wide range of displacement in the X direction.

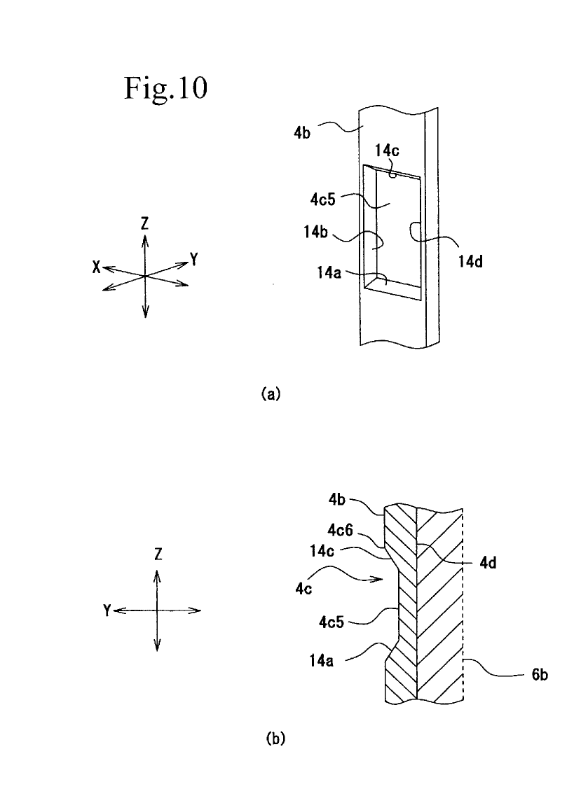

### Sixth Embodiment (FIGS. 10A and 10B)

In some embodiments, the inner walls 4c1 to 4c4 of each recess 4c are formed in the contact surface 4b so as to be perpendicular to the surface of the contact portion 4d. As illustrated in FIGS. 10A and 10B, however, the inner walls 4c1 to 4c4 may be replaced by inclined surfaces 14a to 14d that are inclined so as to be widened from the back wall 4c5 toward the opening side.

In the case where each recess 4c includes the inclined surfaces 14a to 14d, the corresponding front connection portion 5a is allowed to slide over the inclined surfaces 14a to 14d and guided to the inside of the recess 4c while the plug 2 is being fitted into the socket 3. Specifically, the inclined surfaces 14a and 14c guide the front connection portion 5a to the back wall 4c5 in a direction parallel to the Z direction, whereas the inclined surfaces 14b and 14d guide the front connection portion 5a to the back wall 4c5 in a direction parallel to the X direction. In the recess 4c defined by the inclined surfaces 14a to 14d, the back wall 4c5 has a smaller area than that of a recess 4c that has an opening of the same size and that is defined by the inner walls 4c1 to 4c4. Accordingly, the movable range of the front connection portion 5a is smaller, thereby restricting slight sliding movement of the front connection portion 5a. This structure thus prevents removable of the plating of the socket terminal 5 and the plug terminal 4 and facilitates a continuous electrical connection between the terminals.

### Modified Example of Sixth Embodiment

The sixth embodiment has described an example in which the inner walls 4c1 to 4c4 of each recess 4c are replaced by the inclined surfaces 14a to 14d. In contrast, the inclined surfaces 14a to 14d may be provided as, for example, the inner walls of each through hole 11. The inclined surfaces 14a to 14d in such a structure can have the operations and effects of the through holes 11 according to the third embodiment as well as the guide function according to the sixth embodiment.

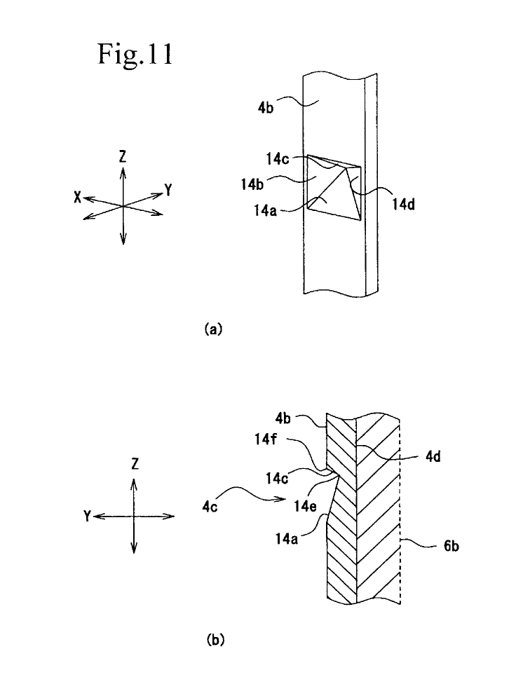

### Seventh Embodiment (FIGS. 11A and 11B)

The sixth embodiment has described an example in which each recess 4c has a back wall 4c5. As illustrated in FIGS. 11A and 11B, however, a recess 4c defined by inclined surfaces 14a to 14d and having an apex 14e, which is the deepest point of the contact portion 4d, may be formed instead. In this structure, the inclined surfaces 14a and 14c can guide the front connection portion 5a to the apex 14e in the Z direction while the inclined surfaces 14b and 14d can guide the front connection portion 5a to the apex 14e in the X direction. The front connection portion 5a that has arrived at a portion near the apex 14e is restricted by the inclined surfaces 14a and 14c in terms of the movement in the Z direction and restricted by the inclined surfaces 14b and 14d in terms of the movement in the X direction. Thus, the front connection portion 5a is fixed around the apex 14e and slight sliding movement can be restricted. This structure thus prevents removable of the plating of the socket terminal 5 and the plug terminal 4 and can maintain a stable electrical connection between the terminals.

In this case, as illustrated in FIG. 11B, an angle of inclination of the inclined surface 14c on the side closer to the plug 2 in the Z direction may be larger than an angle of inclination of the opposing inclined surface 14a. This structure allows the contact edge 5a1 of each front connection portion 5a to easily come into contact with the opening edge 14f and facilitates scraping off the impurities G that have adhered to the front connection portion 5a.

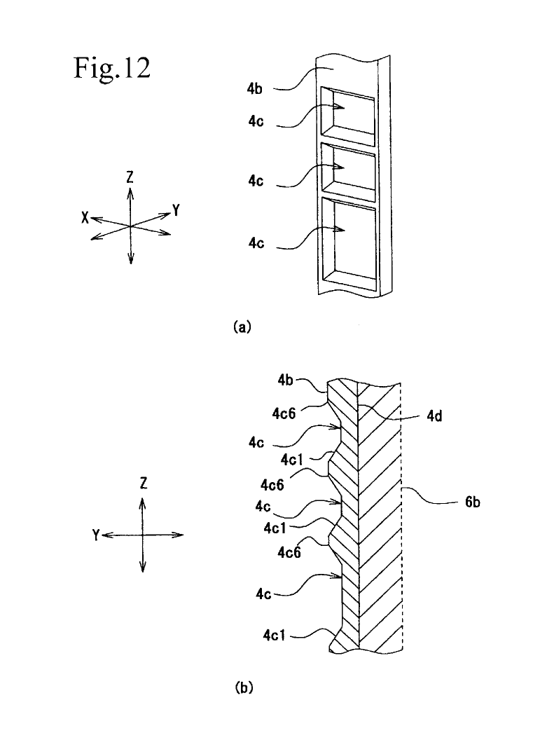

### Eighth Embodiment (FIGS. 12A and 12B)

The above-described embodiments have described examples in which the contact surface 4b has one recess 4c, one through hole 11, or one protrusion 12, which serves as a “locking portion” or an “impurity remover”. However, a plurality of recesses, through holes, or protrusions may be formed in the contact surface 4b. For example, FIGS. 12A and 12B illustrate an example in which multiple recesses 4c are aligned in the Z direction. Alternatively, a recess 4c, a through hole 11, and a protrusion 12 may be provided in combination. Thus, in the example illustrated in FIGS. 12A and 12B, the front connection portion 5a comes into contact with the contact edges 5a1 multiple times while the plug 2 is inserted into the socket 3, whereby the impurities G can be easily scraped off. On the other hand, in case the front connection portion 5a crosses one of the inner walls 4c1 as a result of an application of vibrations to the plug 2 in the direction in which the plug 2 is pulled out from the socket 3, the front connection portion 5a enters another recess 4c on the side closer to the socket 3 in the Z direction and then comes into contact with the inner wall 4c1 and is locked on the inner wall 4c1. Thus, the socket terminal 5 can be more reliably locked on the plug terminal 4, whereby the electrical connection between the socket terminal 5 and the plug terminal 4 can be reliably maintained.

### Other Embodiments

Some of the above-described embodiments have described an example in which one socket terminal 5 includes multiple connection portions (a front connection portion 5a and a rear connection portion 5g). However, one socket terminal may include one connection portion.

In this case, multiple plug terminals that are arranged may include plug terminals that include a “locking portion” and plug terminals that do not include a “locking portion”. In this structure, the socket terminals can be locked on the plug terminals that include a “locking portion”. The plug terminals that do not include a “locking portion” function as members to which the socket terminals are electrically connected.

Some embodiments have described the floating connector 1 as an example of an “electric connector” according to the present invention, but other connectors that can electrically connect circuit boards together can serve as the electric connector.

What is claimed is:

1. An electric connector, comprising a plug including a plug terminal and a socket including a socket terminal, the plug terminal and the socket terminal coming into contact with each other and being electrically connected to each other when the plug and the socket are fitted together,
wherein the socket terminal includes a connection portion that comes into contact with the plug terminal,
wherein the plug terminal includes a locking portion on a contact surface that comes into contact with the connection portion of the socket terminal, the connection portion being locked on the locking portion by coming into contact with the locking portion when moving in a direction in which the plug terminal is pulled out from the socket terminal,
wherein the connection portion of the socket terminal includes a front connection portion and a rear connection portion, each of which includes a contact edge formed of an end portion of a flat metal sheet,
wherein, while the connector is being changed into a fitted state, the contact edge of the front connection portion wipes away an impurity that adheres to the contact surface by contacting the plug terminal until passing the locking portion from an end-side portion of the plug terminal and, while the connector is in the fitted state, the contact edge is locked on the locking portion as a result of the plug moving relative to the socket in the direction in which the plug terminal is pulled out from the socket terminal, and
wherein the contact edge of the rear connection portion comes into contact with the plug terminal subsequent to the front connection portion and is electrically connected with the plug terminal at a position between the locking portion and the end-side portion wiped by the contact edge of the front connection portion.

2. The electric connector according to claim 1, wherein the socket terminal includes an elastic piece that elastically supports the front connection portion and the rear connection portion.

3. The electric connector according to claim 1, wherein the socket terminal includes a front terminal and a rear terminal, the front terminal including an elastic piece that elastically supports the front connection portion, the rear terminal including an elastic piece that elastically supports the rear connection portion.

4. The electric connector according to claim 1, wherein a recess, at which a plate surface of the plug terminal is recessed and into which the contact edge of the front connection portion enters while the plug and the socket are fitted together, is formed in the contact surface of the plug terminal as the locking portion.

5. The electric connector according to claim 1, wherein a through hole, which passes through the thickness of the plug terminal and into which the contact edge of the front connection portion enters while the plug and the socket are fitted together, is formed in the contact surface of the plug terminal as the locking portion.

6. The electric connector according to claim 1, wherein a protrusion, which protrudes from the contact surface of the plug terminal, is disposed on the contact surface of the plug terminal as the locking portion, and wherein the socket terminal and the plug terminal are locked together when the plug terminal moves in the direction in which the plug terminal is pulled out while the plug and the socket are fitted together as a result of the contact edge of the front connection portion crossing the protrusion of the plug terminal.

7. The electric connector according to claim 1, wherein a movable-range gap that allows displacement in directions in which the plug terminal is inserted into and pulled out from the socket terminal while the plug and the socket are fitted together is provided between the contact edge of the front connection portion and the locking portion of the plug terminal so that the plug and the socket are displaceable relative to each other in the directions in which the plug terminal is inserted into and pulled out from the socket terminal while the plug and the socket are fitted together.

8. The electric connector according to claim 1, wherein the contact surface of the plug terminal includes an impurity remover that scrapes the impurity off the contact edge of the socket terminal that has wiped away the impurity as a result of the contact edge sliding over the impurity remover.

9. The electric connector according to claim 1, wherein the contact surface of the plug terminal includes side locking surfaces that restrict sideways displacement of the contact edge of the front connection portion in a width direction of the plug terminal.

10. The electric connector according to claim 1, wherein the contact surface of the plug terminal includes inclined surfaces that position the contact edge of the front connection portion by causing the contact edge to slide over the inclined surfaces in a width direction of the plug terminal.

11. The electric connector according to claim 1, wherein the contact surface of the plug terminal includes inclined surfaces that position the contact edge of the front connection portion by causing the contact edge to slide over the inclined surfaces in at least one of a direction in which the plug terminal is inserted and a direction in which the plug terminal is pulled out.

12. The electric connector according to claim 1, wherein the socket terminal is made of a flat metal sheet having no bent portion in a sheet thickness direction.

13. The electric connector according to claim 1,
wherein the socket terminal includes
a substrate connection portion that is to be fixed to a circuit board,
a movable connection portion including the connection portion, and
a movable portion that elastically supports the substrate connection portion and the movable connection portion so that the substrate connection portion and the movable connection portion are displaceable relative to each other.

14. The electric connector according to claim 1,
wherein the socket includes a fixed housing that is to be fixed to a circuit board and a movable housing that is to be fitted to a housing of the plug, and
wherein the socket terminal includes a movable portion that elastically supports the fixed housing and the movable housing so that the fixed housing and the movable housing are displaceable relative to each other.
